(19) United States
(12) Patent Application Publication
(10) Pub. No.: US 2018/0375096 A1
(43) Pub. Date: Dec. 27, 2018

(54) POSITIVE ELECTRODE ACTIVE MATERIAL FOR NON-AQUEOUS-ELECTROLYTE SECONDARY BATTERY AND NON-AQUEOUS-ELECTROLYTE SECONDARY BATTERY

(71) Applicant: PANASONIC INTELLECTUAL PROPERTY MANAGEMENT CO., LTD., Osaka-shi, Osaka (JP)

(72) Inventors: Yoshinori AOKI, Hyogo (JP); Motoharu SAITO, Hyogo (JP); Takeshi OGASAWARA, Hyogo (JP)

(73) Assignee: Panasonic Intellectual Property Management Co., Ltd., Osaka-shi, Osaka (JP)

(21) Appl. No.: 16/062,007

(22) PCT Filed: Dec. 15, 2016
(86) PCT No.: PCT/JP2016/005137

§ 371 Date: Jun. 13, 2018

(30) Foreign Application Priority Data
Dec. 25, 2015 (JP) 2015-253463

(51) Int. Cl. H01M 4/525; H01M 4/62; H01M 4/66; H01M 4/36; H01M 10/05

(52) U.S. Cl. CPC H01M 4/525; H01M 4/623; H01M 4/505; H01M 4/366; H01M 10/05; H01M 4/661

(57) ABSTRACT

There is provided a positive electrode active material for a non-aqueous-electrolyte secondary battery, the material being represented by a compositional formula LiₓNi_{y}Co_{α}Al_{β}Si_{z}O_{2-y} (where x, y, α, β, z, and γ are within specific ranges and satisfy 0.95<x<1.05, 0.80<y<1, 0<α<0.15, 0<p<0.05, 0<β<0.5, y+α+β=1, 0<z<0.02, and 0≤γ<0.05) and having a layered crystal structure belonging to the space group R-3m. The positive electrode active material contains a layered oxide having the half width n of a diffraction peak for the (211) plane in an X-ray diffraction pattern within 0.28°≤n≤0.50°.

### TECHNICAL FIELD

The present disclosure relates to a positive electrode active material for a non-aqueous-electrolyte secondary battery and a non-aqueous-electrolyte secondary battery.

### BACKGROUND ART

A lithium-nickel composite oxide (LiNiO₂), which is one of positive electrode materials used in lithium-ion secondary batteries, is expected to be a future positive electrode material because the lithium-nickel composite oxide (LiNiO₂) has a higher capacity than a lithium-cobalt composite oxide (LiCoO₂) and an advantage such that nickel is cheaper than cobalt and therefore stably available. The lithium-nickel composite oxide is, however, generally less durable than a lithium-cobalt composite oxide, and studies have been therefore made to enhance the durability of the lithium-nickel composite oxide.

Patent Literature 1 describes a non-aqueous-electrolytic-solution secondary battery that includes a nickel-lithium composite oxide as a positive electrode active material and a non-aqueous electrolytic solution which contains an organic acid at a specific concentration, in which when the nickel-lithium composite oxide contains an element selected from the group consisting of specific metals in addition to at least one of Li, Ni, Co, and Mn, the battery has excellent cycle characteristics at high temperature.

### CITATION LIST

### Patent Literature

PTL 1: Japanese Published Unexamined Patent Application No. 2006-351242

### SUMMARY OF INVENTION

In the case where a nickel-excess lithium-nickel composite oxide is used as a positive electrode active material and where metal other than Li, Ni, Co, and Mn is added to the nickel-excess lithium-nickel composite oxide to enhance durability (cycle characteristics), a problem of a reduction in charge-discharge capacity occurs.

It is an object of the present disclosure to provide a non-aqueous-electrolyte secondary battery that contains a nickel-excess lithium-nickel composite oxide but has a good durability and high charge-discharge capacity.

A positive electrode active material for a non-aqueous-electrolyte secondary battery according to the present disclosure is represented by a compositional formula LiₓNi_{y}Co_{α}Al_{β}Si_{z}O_{2-y} (where x, y, α, β, z, and γ satisfy 0.95<x<1.05, 0.80<y<1, 0<α<0.15, 0<β<0.05, y+α+β=1, 0<z<0.02, and 0≤γ<0.05) and has a layered crystal structure belonging to the space group R-3m. The positive electrode active material contains a layered oxide having the half width n of a diffraction peak for the (211) plane in an X-ray diffraction pattern within 0.28°≤n≤0.50°.

According to the present disclosure, a non-aqueous-electrolyte secondary battery having a good durability and high charge-discharge capacity can be produced although a positive electrode active material contains a nickel-excess lithium-nickel composite oxide.

### BRIEF DESCRIPTION OF DRAWINGS

FIG. 1 illustrates powder X-ray diffraction patterns of lithium-nickel composite oxides produced in Examples and Comparative Examples.

FIG. 2 is an enlarged view illustrating part of the powder X-ray diffraction patterns of the lithium-nickel composite oxides produced in Examples and Comparative Examples.

FIG. 3 is an enlarged view illustrating another part of the powder X-ray diffraction patterns of the lithium-nickel composite oxides produced in Examples and Comparative Examples.

### DESCRIPTION OF EMBODIMENTS

When the crystallinity of a lithium-nickel composite oxide is enhanced by addition of metal thereto to improve durability, charge-discharge capacity is reduced because of, for example, the excessive growth of the crystallite. When the crystallinity of a lithium-nickel composite oxide is excessively low, the framework of the crystal structure is fragile, which results in reduced durability. Hence, in the case where a nickel-excess lithium-nickel composite oxide is used as a positive electrode active material, it has been difficult to achieve both enough charge-discharge capacity and durability.

The inventors have intensively studied and found the following: adding a specific amount of silicon to a lithium-nickel composite oxide strengthens the bond between oxygen and transition metals as the framework of the crystal structure, and this stabilized structure enables an enhancement in durability; and adjusting the half width n of a diffraction peak for the (211) plane, which indicates the intralayer and interlayer arrangement of the transition metals, to be 0.28°≤n≤0.50° enables a non-aqueous-electrolyte secondary battery to have a high charge-discharge capacity. Thus, even a non-aqueous-electrolyte secondary battery that contains a nickel-excess lithium-nickel composite oxide as a positive electrode active material can satisfy both good durability and high charge-discharge capacity.

An example of embodiments of the present disclosure will now be described in detail.

A non-aqueous-electrolyte secondary battery (also simply referred to as “secondary battery”) as an example of embodiments of the present disclosure includes a positive electrode, a negative electrode, and a non-aqueous electrolyte. It is suitable that a separator be provided between the positive electrode and the negative electrode. The non-aqueous-electrolyte secondary battery has, for example, a structure in which a rolled electrode body and the non-aqueous electrolyte are accommodated in a housing. The positive electrode and the negative electrode have been wound with the separator interposed therebetween to form the rolled electrode body. Instead of the rolled electrode body, another type of electrode body, such as a layered electrode body in which the positive electrode and the negative electrode are stacked with the separator interposed therebetween, may be used. The non-aqueous-electrolyte secondary battery may be in any shape of, for instance, a cylinder, square, coin, button, or laminate.

[Positive Electrode]

The positive electrode, for example, includes a positive electrode current collector, such as metal foil, and a positive electrode active material layer formed on the positive electrode current collector. A usable positive electrode current collector is the foil of metal, such as aluminum, that is stable within the potential of the positive electrode, or a film having a surface layer of such metal. The positive electrode active material layer suitably contains a conductive agent and a binder in addition to the positive electrode active material. The conductive agent is used to enhance the electric conductivity of the positive electrode active material layer.

Examples of the conductive agent include carbon materials such as carbon black, acetylene black, KETJENBLACK, and graphite. One of these materials may be used alone, or two or more of these materials may be used in combination. The conductive agent content is preferably from 0.1 to 30 mass %, more preferably from 0.1 to 20 mass %, and still more preferably from 0.1 to 10 mass % relative to the total mass of the positive electrode active material layer.

The binder is used to keep the positive electrode active material and the conductive agent being in good contact with each other and to enhance the binding property of, for instance, the positive electrode active material to the surface of the positive electrode current collector. Examples of the binder include polytetrafluoroethylene (PTFE), polyvinylidene fluoride, polyvinyl acetate, polymethacrylate, polyacrylate, polyacrylonitrile, polyvinyl alcohol, and mixtures of two or more of these compounds. The binder may be used in combination with a thickener such as carboxymethyl cellulose (CMC) or polyethylene oxide (PEO). One of these materials may be used alone, or two or more of these materials may be used in combination. The binder content may be, for example, preferably from 0.1 to 30 mass %, more preferably from 0.1 to 20 mass %, and still more preferably from 0.1 to 10 mass % relative to the total mass of the positive electrode active material layer.

The positive electrode active material will now be described in detail.

The positive electrode active material for a non-aqueous-electrolyte secondary battery (also simply referred to as “positive electrode active material”) as an example of embodiments of the present disclosure contains a lithium-nickel layered oxide. The lithium-nickel layered oxide is represented by Compositional Formula (1) and has a layered crystal structure belonging to the space group R-3m, and the half width n of a diffraction peak for the (211) plane in an X-ray diffraction pattern of the lithium-nickel layered oxide is within a specific range. The lithium-nickel layered oxide, which is contained in the positive electrode active material according to the present disclosure and represented by Compositional Formula (1), is also simply referred to as “layered oxide”.

The layered oxide is represented by Compositional Formula (1).

LiₓNi_{y}Co_{α}Al_{β}Si_{z}O_{2-y} (1)

In the formula x, y, α, β, z, and γ satisfy 0.95<x<1.05, 0.80<y<1, 0 <α<0.15, 0<β<0.05, y+α+β=1, 0<z≤0.02, and 0≤γ<0.05.

As specified is Compositional Formula (1) r the total amount of the elements Si, Co, and Al is 1 mol, in other words, the molar content thereof is within y+α+β=1. In the description of, for instance, the crystal structure of the layered oxide, not only Ni and Co are also Al existing in the same layer as Ni and Co are comprehensively referred to as “transition metal” in some cases.

In Compositional Formula (1), x represents the amount (molar ratio) of lithium (Li) relative to the total amount of Ni, Co, and Al. The lithium content within 0.95<x<1.05 enables an enhancement in the charge-discharge capacity of the non-aqueous-electrolyte secondary battery.

In Compositional Formula (1), y represents the amount (molar ratio) of nickel (Ni) relative to the total amount of Ni, Co, and Al. The nickel content within 0.80<y<1 enables an enhancement in the charge-discharge capacity of the non-aqueous-electrolyte secondary battery. From this point of view, y in Compositional Formula (1) is preferably within 0.85<y<1.

In Compositional Formula (1), α represents the amount (molar ratio) of cobalt (Co) relative to the total amount of Ni, Co, and Al. The presence of cobalt in the layered oxide contributes to an enhancement in the durability of the non-aqueous-electrolyte secondary battery. The cobalt content within α<0.15 enables an enhancement in the charge-discharge capacity of the non-aqueous-electrolyte secondary battery. In Compositional Formula (1) α is preferably within 0.03<α<0.12.

In Compositional Formula (1), β represents the amount (molar ratio) of aluminum (Al) relative to the total amount of Ni, Co, and Al. The presence of aluminum in the layered oxide contributes to an enhancement in the durability of the non-aqueous-electrolyte secondary battery. The aluminum content within β<0.05 enables an enhancement in the charge-discharge capacity of the non-aqueous-electrolyte secondary battery. In Compositional Formula (1) β is preferably within 0.005<β<0.05.

In Compositional Formula (1), z represents the amount (molar ratio) of silicon (Si) relative to the total amount of Ni, Co, and Al. The silicon content within 0<z≤0.02 in the layered oxide enables an enhancement in the durability of the non-aqueous-electrolyte secondary battery. This is believed to be attributed to the following mechanism: silicon is incorporated into the layered oxide to enhance the covalency between oxygen and transition metals contained in the layered oxide, so that the bulk structure of the layered oxide has a strong framework. An excessive amount of silicon may cause generation of lithium-silicon oxide in some cases, which results in a reduction in charge-discharge capacity. From this viewpoint, z in Compositional Formula (1) is preferably within 0.005≤z≤0.02, and more preferably within 0.008≤z≤0.012

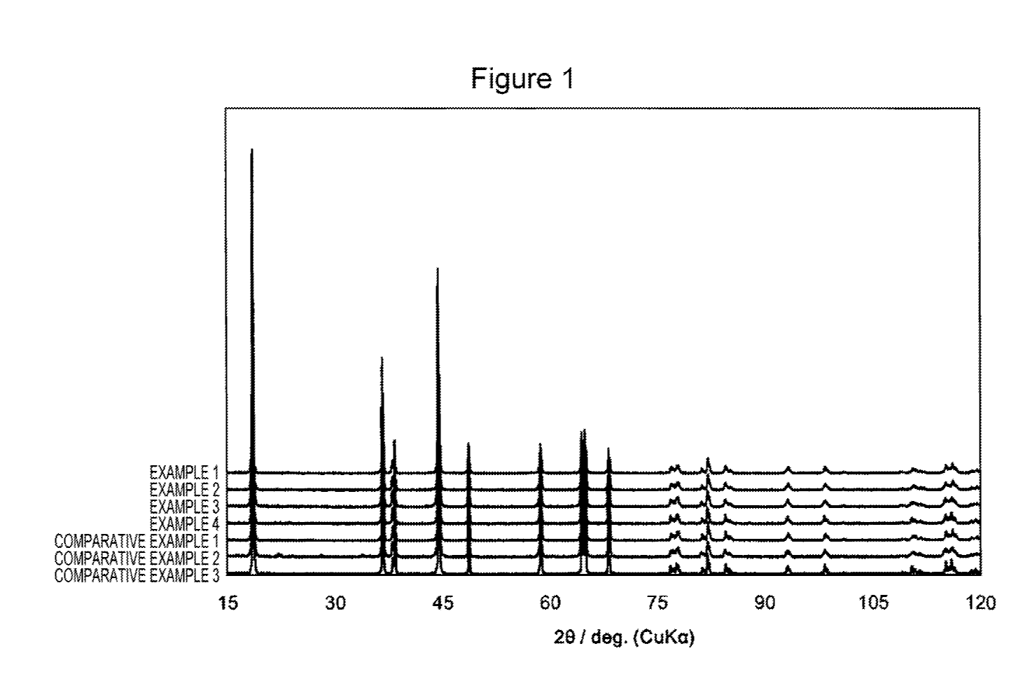

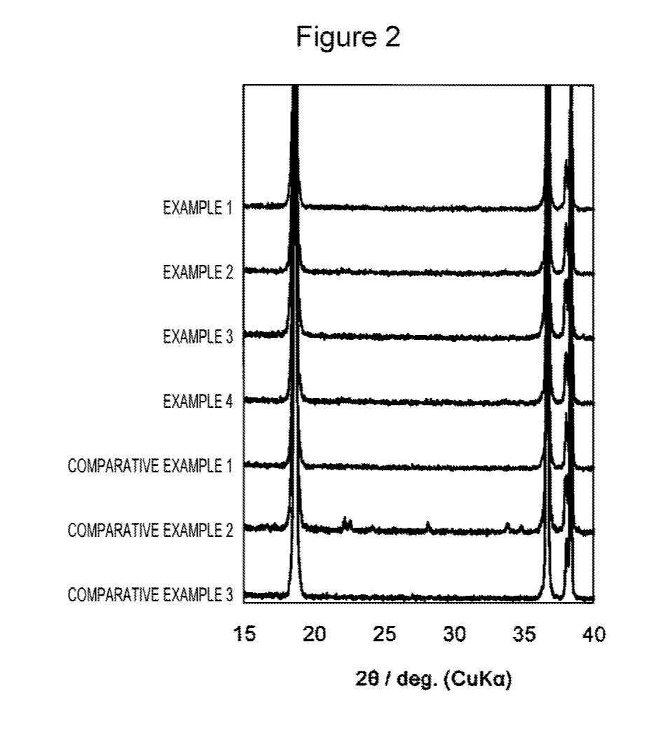

FIG. 1 illustrates X-ray diffraction patterns obtained by a powder X-ray diffractometric analysis of lithium-nickel composite oxides having different compositions or prepared under different conditions. FIG. 2 is an enlarged view illustrating the X-ray diffraction patterns in FIG. 1 at a diffraction angle (2θ) ranging from 15° to 40°. In the X-ray diffraction patterns illustrated in FIGS. 1 and 2, X-ray diffraction peaks showing the existence of a lithium-silicon oxide appear near 22°, 28°, and 34°.

In Compositional Formula (1), “2−γ” represents the amount (molar ratio) of the oxygen atom (O) relative to the total amount of Ni, Co, and Al. In particular, γ represents the degree of oxygen deficiency. The more the value of γ increases, the more the amount of divalent Ni increases; as a result, the layered oxide has a rock-salt structure, in other words, turns into “rock salt”. This mechanism is presumed to cause a decrease in charge-discharge capacity. Hence, γ that is the promoter for the conversion into a rock salt is adjusted to be within 0≤γ<0.05, thereby being able to enhance charge-discharge capacity.

The layered oxide may contain metal elements other than Li, Ni, Co, Al, and Si without departing from the scope of the present disclosure. Since the layered oxide contains Ni in a large amount exceeding 0.80, using, for example, manganese (Mn) in place of Al causes a reduction in the durability. In a preliminary test carried out by the inventors, for instance, capacity retention after 100 cycles is approximately 90% in the case where Al content is 0.03 while the capacity retention after 100 cycles is decreased to approximately 85% in the case where Mn content is 0.03. Accordingly, the layered oxide is preferably free from Mn.

The crystal structure belonging to the space group R-3m is a structure including a stack of a lithium-oxygen octahedral layer and a transition metal-oxygen octahedral layer; for instance, lithium nickel oxide (LiNiO₂) and lithium cobalt oxide (LiCoO₂) have this crystal structure. The layered oxide represented by Compositional Formula (1) is believed to have such a crystal structure belonging to the space group R-3m.

Whether the layered oxide has the crystal structure belonging to the space group R-3m or not can be confirmed from its X-ray diffraction pattern.

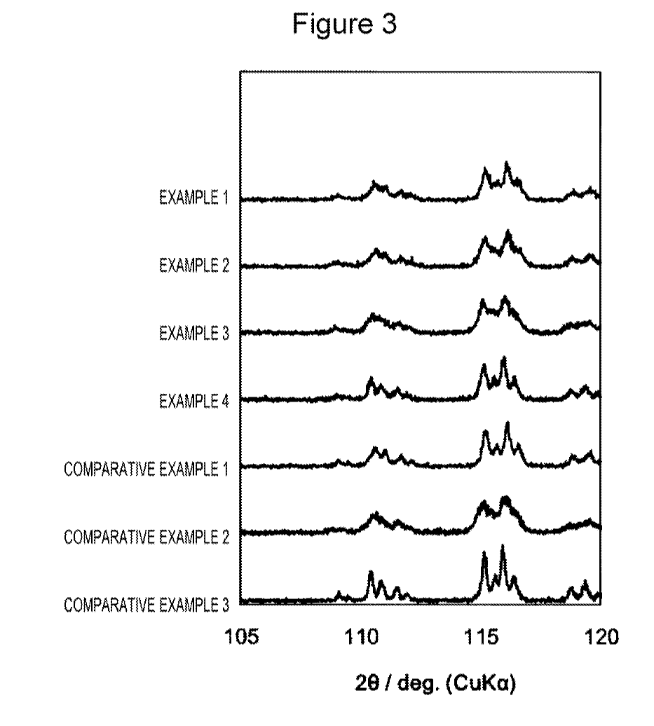

The positive electrode active material as an example of embodiments of the present disclosure is characterized in that the positive electrode active material contains a layered oxide in which the half width (full width at half maximum) n of a diffraction peak for the (211) plane in an X-ray diffraction pattern is within 0.28°≤n≤0.50°. FIG. 3 is an enlarged view illustrating the X-ray diffraction patterns in FIG. 1 at a diffraction angle (2θ) ranging from 105° to 120°. In the diffraction patterns illustrated in FIG. 3, the X-ray diffraction peak for the (211) plane of the layered oxide appears near a diffraction angle (2θ) of 110°.

The half width n of the diffraction peak for the (211) plane in the X-ray diffraction pattern of the layered oxide is believed to indicate the state of the intralayer and interlayer arrangement of transition metals (Ni, Co, and Al) in the crystal structure belonging to the space group R-3m. At the half width n ranging from 0.28°≤n≤0.50°, the intralayer and interlayer arrangement of transition metals in the layered oxide has an appropriate “fluctuation”, and binding of lithium becomes weak; this is presumed to contribute to high charge-discharge capacity in the secondary battery. Excessively large half width n of greater than 0.50 reduces the crystallinity of the layered oxide and therefore makes the framework of the crystal structure fragile, and thus the crystal structure belonging to the space group R-3m cannot be maintained; this is believed to cause a reduction in the durability. From this viewpoint, the half with n of the diffraction peak for the (211) plane in the X-ray diffraction pattern of the layered oxide is preferably within 0.28°≤n≤0.50°, and more preferably within 0.40°≤n≤0.45°.

With reference to FIGS. 1 and 3 illustrating the diffraction patterns of the layered oxide represented by Compositional Formula (1) and lithium-nickel composite oxides other than the layered oxide, the half width n of the diffraction peak for the (211) plane (near a diffraction angle (2θ) of 110°) varies, while the half width m of a diffraction peak for the (003) plane (near a diffraction angle (2θ) of 18°) as the main peak is from 0.14 to 0.15 and does not clearly vary. The diffraction peak for the (003) plane indicates the state of the arrangement of the transition metal layer and lithium layer in the direction of the stacking. Accordingly, in the present invention, the crystal structure of the layered oxide in the direction of the stack of the layers is not changed, but only the intralayer and interlayer arrangement of the transition metals are adjusted to be in such a range that an appropriate fluctuation occurs.

The half width n of the diffraction peak for the (211) plane in the layered oxide can be controlled by, for example, adjusting the conditions in production of the layered oxide. Specifically, in synthesis of the layered oxide, the duration of firing a mixture of metal compounds as raw materials can be prolonged to narrow the half width n. Furthermore, the half width n can be controlled by adjusting z in Compositional Formula (1), which represents the Si content; for example, the more the Si content z is increased, the wider the half width n becomes. In addition, an increase in the firing temperature also enables the half width n to be narrowed. Controlling the half width n by any of these procedures does not cause any specific variation of the half width m of the diffraction peak for the (003) plane.

In the layered oxide, the size s of crystallite that is calculated by Scherrer Equation from the half width of a diffraction peak for the (104) plane in an X-ray diffraction pattern obtained by a powder X-ray diffractometric analysis is preferably within 1200 Å≤s≤2800 Å. Scherrer Equation is represented by Equation (2).

[Math. 1]

D=Kλ/B cos θ (2)

In Equation (2), D represents the size of crystallite, λ represents the wavelength of the X ray, B represents the full width at half maximum of the diffraction peak for the (104) plane, θ represents a diffraction angle (rad), and K is a Scherrer constant. In the present embodiment, K is 0.9.

In the case where the size s of the crystallite of the layered oxide is smaller than 1200 Å, crystallinity is deteriorated in some cases, which may result in a reduction in the durability. In the case where the size s of the crystallite of the layered oxide is greater than 2500 Å, rate characteristics are deteriorated in some cases. The layered oxide of which the size s of the crystallite is within 1200 Å≤s=2800 Å can be prepared by, for example, changing the duration of the firing time. The size s of the crystallite is preferably within 1200 Å≤s≤2200 Å.

The layered oxide represented by Compositional Formula (1) can be, for example, synthesized by mixing a Li compound, a Ni—Co—Al compound, and a Si compound with each other at a mixing ratio based on the intended layered oxide and then firing the mixture. The mixture is fired in the atmosphere or under an oxygen flow. The firing temperature is approximately from 600 to 1100° C., and the firing time is approximately from 1 to 50 hours in the case where the firing temperature is from 600 to 1100° C. As described above, the duration of the firing time can be appropriately adjusted to synthesize the layered oxide having the intended half width n of the diffraction peak for the (211) plane.

In addition to the layered oxide represented by Compositional Formula (1), other silicon oxides may be used without departing from the scope of the present disclosure. The amount of such a silicon oxide is preferably 1 mass % or less relative to the amount of the layered oxide represented by Compositional Formula (1).

The proportion of the layered oxide to the amount of the whole positive electrode active material is preferably 90% or more, and more preferably 99% or more.

[Negative Electrode]

The negative electrode includes, for example, a negative electrode current collector, such as metal foil, and a negative electrode active material layer formed on the surface of the negative electrode current collector. A usable negative electrode current collector is the foil of metal, such as aluminum or copper, that is stable within the potential of the negative electrode, or a film having a surface layer of such metal. The negative electrode active material layer suitably contains a binder in addition to the negative electrode active material that can store and release lithium ions. The negative electrode active material layer may optionally contain a conductive agent.

Examples of a usable negative electrode active material include natural graphite, artificial graphite, lithium, silicon, carbon, tin, germanium, aluminum, lead, indium, gallium, lithium alloys, lithium-storing carbon and silicon, and alloys and mixtures of these substances. The binder can be PTFE or another material as in the positive electrode; however, it is preferably a styrene-butadiene copolymer (SBR) or a modified product thereof. The binder may be used in combination with a thickener such as CMC.

[Non-Aqueous Electrolyte]

The non-aqueous electrolyte contains a non-aqueous solvent and an electrolyte salt dissolved in the non-aqueous solvent. The non-aqueous electrolyte is not limited to a liquid electrolyte (non-aqueous electrolytic solution) and may be a solid electrolyte such as a gel polymer electrolyte. Examples of a usable non-aqueous solvent include esters, ethers, nitriles such as acetonitrile, amides such as dimethylformamide, and mixed solvents of two or more of these solvents.

Examples of the esters include cyclic carbonates such as ethylene carbonate, propylene carbonate, and butylene carbonate; chain carbonates such as dimethyl carbonate, methylethyl carbonate, diethyl carbonate, methylpropyl carbonate, ethylpropyl carbonate, and methylisopropyl carbonate; and carboxylate such as methyl acetate, ethyl acetate, propyl acetate, methyl propionate, ethyl propionate, and γ-butyrolactone.

Examples of the ethers include cyclic ethers, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

The non-aqueous solvent suitably contains a halogen-substituted compound resulting from the substitution of the hydrogen atoms of any of the above-mentioned solvents with halogen atoms such as fluorine atoms. In particular, the non-aqueous solvent preferably contains a fluorinated cyclic carbonate or a fluorinated chain carbonate, and more preferably a mixture of these two carbonates. This enables formation of good protective films on the negative electrode and also on the positive electrode, which leads to an enhancement in cycle characteristics. Suitable examples of the fluorinated cyclic carbonate include 4-fluoroethylene carbonate, 4,5-difluoroethylene carbonate, 4,4-difluoroethylene carbonate, 4,4,5-trifluoroethylene carbonate, and 4,4,5,5-tetrafluoroethylene carbonate. Suitable examples of the fluorinated chain esters include ethyl 2,2,2-trifluoroacetate, methyl 3,3,3-trifluoropropionate, and methyl pentafluoropropionate.

The electrolyte salt is preferably a lithium salt. Examples of the lithium salt include LiPF₆, LiBF4, LiAsF₆, LiClO₄, LiCF₃So₃, LiN(FSO₂)₂, LiN(C₁F₂₁₊₁SO₂)(CₘF₂ₘ₊₁SO₂) (1 and m are each an integer of 1 or more), LiC(CₚF2ₚ₊₁SO₂)(C_{q}F_{2q+1}SO₂)(CᵣF₂ᵣ₊₁SO₂) (p, q, and r are each an integer of 1 or more), Li[B(C₂O₄)₂] (lithium bis(oxalate)borate (LiBOB)), Li [B(C₂O₄)F₂], Li [P(C₂O₄) F₄], Li [P(C₂O₄)SF₂], and LiPO₂F₂. One of these lithium salts may be used alone or two or more these lithium salts may be used in combination.

[Separator]

The separator may be a porous sheet having ion permeability and insulating properties. Specific examples of the porous sheet include microporous thin films, woven fabrics, and non-woven fabrics. Suitable examples of the material of the separator include olefin resins, such as polyethylene and polypropylene, and celluloses. The separator may be a laminate having a cellulose fiber layer and a thermoplastic resin fiber layer such as an olefin resin layer.

### EXAMPLES

The present disclosure will now be described further in detail with reference to Examples but is not limited thereto.

### Example 1

[Preparation of Positive Electrode Active Material (Lithium-Nickel Layered Oxide)]

A nickel-cobalt-aluminum composite hydroxide represented by a compositional formula Ni_{0.88}Co_{0.09}Al_{0.93}(OH)_{Z} was prepared by coprecipitation and then heated at 500° C. to yield a composite oxide. Then, LiOH, this composite oxide, and SiO were mixed with each other in such amounts that Li, the total of transition metals (Ni, Co, and Al), and Si had a molar ratio of 1.03:1:0.005. The resulting mixture was fired at 750° C. for 10 hours under an oxygen flow to prepare a layered oxide A1 represented by a compositional formula

The crystal structure of the layered oxide A1 was analyzed by powder X-ray diffractometry with a powder X-ray diffractometer (manufactured by Rigaku Corporation, tradename “RINT2200”, radiation source: Cu-Kα). The result of the analysis showed that the crystal structure of the layered oxide A1 was a layered crystal structure belonging to the space group R-3m and that the half width n (2θ) of a diffraction peak for the (211) plane was 0.40°. The size s of the crystallite was calculated by Scherrer Equation on the basis of the half width of a diffraction peak for the (104) plane and the diffraction angle in the manner described above and found to be 1486 Å.

[Formation of Positive Electrode]

With 91 parts by mass of the layered oxide A1 prepared as a positive electrode active material, 7 parts by mass of acetylene black as a conductive agent and 2 parts by mass of polyvinylidene fluoride as a binder were mixed. The mixture was kneaded with a kneader (T.K. HIVIS MIX manufactured by PRIMIX Corporation) to prepare a positive electrode mixture slurry. The positive electrode mixture slurry was applied to aluminum foil having a thickness of 15 μm, and the coating film was dried to form a layer of the positive electrode mixture slurry on the aluminum foil, thereby forming an electrode (positive electrode).

[Preparation of Non-Aqueous Electrolyte]

Ethylene carbonate (EC), methylethyl carbonate (MEC), and dimethyl carbonate (DMC) were mixed with each other at a volume ratio of 3:3:4. Lithium hexafluorophosphate (LiPF₆) was dissolved in this mixed solvent at a concentration of 1.2 mol/L to prepare a non-aqueous electrolyte.

[Production of Test Cell]

The positive electrode and lithium metal foil as a negative electrode were stacked so as to face each other with a separator interposed therebetween and wound to produce a rolled electrode body. The rolled electrode body and the non-aqueous electrolyte were put inside an aluminum housing to produce a non-aqueous-electrolyte secondary battery (test cell A1).

### Example 2

A layered oxide A2 represented by a compositional formula Li_{1.03}Ni_{0.88}Co_{0.09}Al_{0.03}Si_{0.01}O₂ and a non-aqueous-electrolyte secondary battery (test cell A2) were produced as in Example 1 except that LiOH, the composite oxide, and SiO were mixed with each other in the preparation of the positive electrode active material in such amounts that Li, the total of transition metals (Ni, Co, and Al), and Si had a molar ratio of 1.03:1:0.01. The crystal structure of the layered oxide A2 was analyzed by powder X-ray diffractometry. The result of the analysis showed that the crystal structure of the layered oxide A2 was a layered crystal structure belonging to the space group R-3m and that the half width n (2θ) of a diffraction peak for the (211) plane was 0.45°. The size s of the crystallite was calculated and found to be 1480 Å.

### Example 3

A layered oxide A3 represented by a compositional formula Li_{1.03}Ni_{0.99}Co_{0.09}Al_{0.03}Si_{0.02}O₂ and a non-aqueous-electrolyte secondary battery (test cell A3) were produced as in Example 1 except that LiOH, the composite oxide, and SiO were mixed with each other in the preparation of the positive electrode active material in such amounts that Li, the total of transition metals (Ni, Co, and Al), and Si had a molar ratio of 1.03:1:0.02. The crystal structure of the layered oxide A3 was analyzed by powder X-ray diffractometry. The result of the analysis showed that the crystal structure of the layered oxide A3 was a layered crystal structure belonging to the space group R-3m and that the half width n (2θ) of a diffraction peak for the (211) plane was 0.50°. The size s of the crystallite was calculated and found to be 1690 Å.

### Example 4

A layered oxide A4 represented by a compositional formula Li_{1.03}Ni_{0.88}Co_{0.09}Al_{0.03}Si_{0.01}O₂ and a non-aqueous-electrolyte secondary battery (test cell A4) were produced as in Example 2 except that the mixture of LiOH, the composite oxide, and SiO was fired at 750° C. for 20 hours under an oxygen flow in the preparation of the positive electrode active material. The crystal structure of the layered oxide A4 was analyzed by powder X-ray diffractometry. The result of the analysis showed that the crystal structure of the layered oxide A4 was a layered crystal structure belonging to the space group R-3m and that the half width n (2θ) of a diffraction peak for the (211) plane was 0.28°. The size s of the crystallite was calculated and found to be 2524 Å.

### Comparative Example 1

A layered oxide B1 represented by a compositional formula Li_{1.03}Ni_{0.88}Co_{0.09}Al_{0.03}O₂ and a non-aqueous-electrolyte secondary battery (test cell B1) were produced as in Example 1 except that SiO was not used in the preparation of the positive electrode active material and that LiOH and the composite oxide were mixed with each other in such amounts that Li and the total of transition metals (Ni, Co, and Al) had a ratio of 1.03:1. The crystal structure of the layered oxide B1 was analyzed by powder X-ray diffractometry. The result of the analysis showed that the crystal structure of the layered oxide B1 was a layered crystal structure belonging to the space group R-3m and that the half width n (2θ) of a diffraction peak for the (211) plane was 0.36°. The size s of the crystallite was calculated and found to be 1527 Å.

### Comparative Example 2

A layered oxide B2 represented by a compositional formula Li_{1.03}Ni_{0.88}Co_{0.09}Al_{0.03}Si_{0.03}O₂ and a non-aqueous-electrolyte secondary battery (test cell B2) were produced as in Example 1 except that LiOH, the composite oxide, and SiO were mixed with each other in the preparation of the positive electrode active material in such amounts that Li, the total of transition metals (Ni, Co, and Al), and Si had a molar ratio of 1.03:1:0.03. The crystal structure of the layered oxide B2 was analyzed by powder X-ray diffractometry. The result of the analysis showed that the crystal structure of the layered oxide B2 was a layered crystal structure belonging to the space group R-3m and that the half width n (2θ) of a diffraction peak for the (211) plane was 0.64°. The size s of the crystallite was calculated and found to be 1192 Å.

### Comparative Example 3

A layered oxide B3 represented by a compositional formula Li_{1.03}Ni_{0.88}Co_{0.09}Al_{0.03}Si_{0.03}O₂ and a non-aqueous-electrolyte secondary battery (test cell B3) were produced as in Example 2 except that the mixture of LiOH, the composite oxide, and SiO was fired at 750° C. for 40 hours under an oxygen flow in the preparation of the positive electrode active material. The crystal structure of the layered oxide B3 was analyzed by powder X-ray diffractometry. The result of the analysis showed that the crystal structure of the layered oxide B3 was a layered crystal structure belonging to the space group R-3m and that the half width n (2θ) of a diffraction peak for the (211) plane was 0.18°. The size s of the crystallite was calculated and found to be 3320 Å.

[Output Characteristics Test]

The produced test cells A1 to A4 and B1 to B3 were subjected to constant-current charge at 25° C. and a current value of 6 mA to a voltage of 4.3 V and then underwent constant-voltage charge at 4.3V to a current value of 1.5 mA. The test cells were subsequently subjected to a constant-current discharge at 1.5 mA to a voltage of 2.5 V. The capacity discharged from the test cells in the constant-current discharge was defined as the initially discharged capacity (mAh/g) of the test cells.

Then, each of the test cells A1 to A4 and B1 to B3 was repeatedly subjected to the following cycle of charge and discharge. The charge and discharge were carried out at an environmental temperature of 25° C. Constant-current charge was carried out first at a current value of 6 mA to a voltage of 4.3 V, and then constant-voltage charge was carried out at 4.3 V to a current value of 1.5 mA. Then, constant-current discharge was carried out at a current value of 1.5 mA to a discharge cut-off voltage of 2.5 V. The charge and the discharge were performed with an interval of 20 minutes therebetween. This cycle of charge and discharge was performed 40 times. The proportion (percentage) of the capacity discharged in the 40th cycle to the initially discharged capacity was determined as capacity retention, and the cycle characteristics of the test cells were evaluated on the basis of the capacity retention.

Table 1 shows Si content s (molar ratio) in each of the layered oxides A1 to A4 and B1 to B3, the firing condition in the preparation of the layered oxide, the half width n of the diffraction peak for the (211) plane, and the size s of the crystallite. Table 1 also shows the initially discharged capacity and capacity retention of the test cells A1 to A4 and B1 to B3, which were determined in Output Characteristics Test.

TABLE 1

| | Positive electrode active material | | | | | | | Test cell | | |
|---|---|---|---|---|---|---|---|---|---|---|
| | | Si | | Half width | | | | | Initially | |
| | | content | | for (211) | Size of | | | | discharged | Capacity |
| | | (molar | Firing | plane | crystallite | a axis | c axis | | capacity | retention |
| | Number | ratio) | conditions | (°) | (Å) | (Å) | (Å) | Number | (mAh/g) | (%) |
| Example 1 | A1 | 0.005 | 750° C. | 0.4 | 1486 | 2.8683 | 14.189 | A1 | 224 | 94.4 |
| | | | 10 hours | | | | | | | |
| Example 2 | A2 | 0.01 | 750° C. | 0.45 | 1480 | 2.8679 | 14.185 | A2 | 224 | 97.8 |
| | | | 10 hours | | | | | | | |
| Example 3 | A3 | 0.02 | 750° C. | 0.5 | 1690 | 2.8682 | 14.19 | A3 | 204 | 98.2 |
| | | | 10 hours | | | | | | | |
| Example 4 | A4 | 0.01 | 750° C. | 0.28 | 2524 | 2.8672 | 14.185 | A4 | 208 | 98 |
| | | | 20 hours | | | | | | | |
| Comparative | B1 | 0 | 750° C. | 0.36 | 1527 | 2.8686 | 14.191 | B1 | 224 | 88.3 |
| Example 1 | | | 10 hours | | | | | | | |
| Comparative | B2 | 0.03 | 750° C. | 0.64 | 1192 | 2.8691 | 14.194 | B2 | 191 | 99.1 |
| Example 2 | | | 10 hours | | | | | | | |
| Comparative | B3 | 0.01 | 750° C. | 0.18 | 3320 | 2.867 | 14.187 | B3 | 196 | 98.5 |
| Example 3 | | | 40 hours | | | | | | | |

FIG. 1 illustrates the X-ray diffraction patterns of the layered oxides A1 to A4 and B1 to B3 produced in Examples 1 to 4 and Comparative Examples 1 to 3. FIG. 2 is an enlarged view illustrating the X-ray diffraction patterns near a diffraction angle (2θ) ranging from 15° to 40°. FIG. 3 is an enlarged view illustrating the X-ray diffraction patterns near a diffraction angle (2θ) ranging from 105° to 120°.

As is obvious from Table 1, the more the Si content z in the layered oxides was, the higher the capacity retention of the test cells was. The cause thereof is believed to be as follows: covalency between oxygen atoms and transition metals was enhanced owing to replacement of a transition metal such as Ni with the incorporated Si, and thus the framework of the bulk structure was strengthened.

In Comparative Example 2 in which the Si content z exceeded the range according to the present disclosure, the initially discharged capacity was low. In FIG. 2, an X-ray diffraction peak for a lithium-silicon oxide was clearly observed in the X-ray diffraction pattern of Comparative Example 2. In particular, since Si content was in excess in the layered oxide B2 of Comparative Example 2, the lithium and silicon contained in the positive electrode active material formed a composite oxide; thus, the quantity of mobile lithium decreased, and this is presumed to cause the low initially discharged capacity.

As is obvious from comparison among the results of Example 2, Example 4, and Comparative Example 3, even when the Si contents z were the same, the larger the half width n of the diffraction peak for the (211) plane was, the more the initially discharged capacity was. In addition, the more the half width n was, the smaller the capacity retention was. The half width, n of the diffraction peak for the (211) plane (2θ=near 110°) indicates the state of the intralayer and interlayer arrangement of the transition metals. The half width n was within a specific range in the secondary battery containing the positive electrode active material according to the present disclosure, and thus an appropriate fluctuation occurred in the intralayer and interlayer arrangement of the transition metals; it is believed that this enabled the high initially discharged capacity.

As described above, the silicon content and the half width of the diffraction peak for the (211) plane are adjusted in the nickel-excess lithium-nickel composite oxide in the present embodiment, so that a non-aqueous-electrolyte secondary battery having a good durability and high charge-discharge capacity can be produced.

### INDUSTRIAL APPLICABILITY

The present invention can be applied to a positive electrode active material for a non-aqueous-electrolyte secondary battery and to a non-aqueous-electrolyte secondary battery.

1. A positive electrode active material for a non-aqueous-electrolyte secondary battery, the material comprising a layered oxide represented by a compositional formula LiₓNi_{y}Co_{α}Al_{β}Si_{z}O_{2-γ} (where x, y, α, β, z, and γ satisfy 0.95<x<1.05, 0.80<y<1, 0<α<0.15, 0<β<0.05, y+α+β=1, 0<z≤0.02, and 0≤γ<0.05), the layered oxide having a layered crystal structure belonging to a space group R-3m and having half width n of a diffraction peak for a (211) plane in an X-ray diffraction pattern within 0.28°≤n≤0.50°.

2. The positive electrode active material for a non-aqueous-electrolyte secondary battery according to claim 1, wherein a size s of crystallite of the layered oxide that is calculated by Scherrer Equation based on half width of a diffraction peak for a (104) plane in the X-ray diffraction patter is within 1200 Å≤a≤2800 Å.

3. A son-aqueous-electrolyte secondary battery comprising a positive electrode containing the positive electrode active material for a non-aqueous-electrolyte secondary battery according to claim 1, a negative electrode, and a non-aqueous electrolyte.
